(19) United States
(12) Patent Application Publication
(10) Pub. No.: US 2016/0182252 A1
(43) Pub. Date: Jun. 23, 2016

(54) Wireless and Powerline Communication Mesh Network

(71) Applicant: Greenvity Communications, Inc., Milpitas, CA (US)

(72) Inventors: Pankaj Razdan, Pune (IN); Bosco Jacinto, Mumbai (IN); Hung C. Nguyen, San Jose, CA (US)

(73) Assignee: Greenvity Communications, Inc., Milpitas, CA (US)

(21) Appl. No.: 14/972,051

(22) Filed: Dec. 16, 2015

Related U.S. Application Data
(60) Provisional application No. 62/095,756, filed on Dec. 22, 2014.

(51) Int. Cl. H04L 12/46; H04L 12/741; H04L 12/28

(52) U.S. Cl. CPC H04L 12/462; H04L 12/2809; H04L 45/54; H04L 2012/2843; H04L 2012/2841

(57) ABSTRACT

A technique to operate a wireless (IEEE 802.15) and powerline (Broadband PLC) mesh network uses bridges to bridge the different network types. Each bridge has a an IEEE 802.15 MAC/PHY and a Broadband PLC MAC/PHY.

### CROSS REFERENCE TO RELATED APPLICATIONS

This application claims priority to and incorporates by reference U.S. Patent Application No. 62/095,756 filed Dec. 22, 2014.

### FIELD OF THE INVENTION

At least one embodiment of the present invention pertains to power line communication, and more particularly, to bridging wireless and powerline networks.

### BACKGROUND

Currently, Intelligent Building Lighting Systems (IBLS) or Home Area Networks (HANs) support either HPGP or IEEE802.15.4. Issues with using only HPGP Powerline Communication (PLC) network include a maximum of 255 nodes and HPGP does not work well when there are multiple phases or phase changes in the powerlines. Issues with using only IEEE802.15.4 include RF issues such as Indoor Multipath fading or signal loss due to multiple walls; interference with existing systems such as WiFi; latency increases as number of devices increase in the network due to increase in number of hops; and packet size is limited to 128 bytes of which 25 bytes is the MAC header. Other issues affecting conventional devices include resource constraints such as memory or CPU processing and battery operated or without battery devices.

Accordingly, a new system and method that combines features of the different networks may be needed.

### SUMMARY

This summary is provided to introduce in a simplified form certain concepts that are further described in the Detailed Description below and the drawings. This summary is not intended to identify essential features of the claimed subject matter or to limit the scope of the claimed subject matter.

In one embodiment, a heterogeneous network comprises at least one wireless (e.g., 802.15) subnetwork and at least one powerline communication (e.g., Broadband Powerline Communication) subnetwork, each of the subnetworks comprising at least one device, the subnetworks bridged by a bridge device. A method in the network comprises: determining, by the bridge device, neighboring nodes after a root node boots; assigning, by the bridge device, a neighboring node closest to the root node as a parent node; receiving, from each device in a subnetwork of the bridge device, a registration request; forwarding, by the bridge device, the registration request, to the root node; and receiving assignments of a network address for each subnetwork device, the network address having a size of two bytes and comprising a network identifier and device identifier.

In an embodiment, the bridge device includes one wireless (e.g., IEEE 802.15) MAC/PHY and one PLC (e.g., Broadband Powerline Communication) MAC/PHY with a processor to execute instructions stored in memory based on the above method.

Other aspects of the technique will be apparent from the accompanying figures and detailed description.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a block diagram illustrating a heterogeneous network.

FIG. 2A is a block diagram illustrating a bridge device.

FIG. 2B is a block diagram illustrating a memory of the bridge device.

FIG. 3 is a block diagram illustrating a heterogeneous network.

FIG. 4 is block diagram illustrating a network topology of the network of FIG. 3.

FIG. 5 is a block diagram illustrating bridge node interfaces.

FIG. 6 is a diagram illustrating a network header appended to packets.

FIG. 7 is a flowchart illustrating a method of transmitting data over a heterogeneous network.

FIG. 8 is a flowchart illustrating a method of processing a packet at a bridge device.

FIG. 9 is a flowchart illustrating a method of processing a received packet at a gateway device.

FIG. 10 is a flowchart illustrating a method of transmitting a packet at a gateway device.

FIG. 11 is a flowchart illustrating a method of assigning an address at a gateway device.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

FIG. 1 is a block diagram illustrating a heterogeneous network 100. The network 100 comprises a mix of IEEE 802.15.4 and Broadband PLC networks with a gateway and bridges between network types. An embodiment includes a scheme so that both of these networks can be used simultaneously such that overall system becomes robust, and extendable. Both of these will complement each other, hence user will get better connectivity and can extend network.

The network 100 can bridge multiple Broadband PLC networks using IEEE802.15.4 networks or vice-versa. In each of the network, there are multiple devices. For e.g., Broadband-PLC network can have multiple PLC devices. Similarly, IEEE802.15.4 network can have multiple such devices. Each of the devices in either of the network can have light, sensor, tablets, mobile phones, computers, etc. and/or other appliances connected to it.

Bridge devices (B11, B12, B21, B22, B31) are the devices which are capable of having both Broadband PLC capability and IEEE802.15.4 capability. Additionally, these devices have capability to store information about other Bridges in the network. In an embodiment, there can be a cap on maximum number of bridges at 255 because of memory constraint of the bridge device.

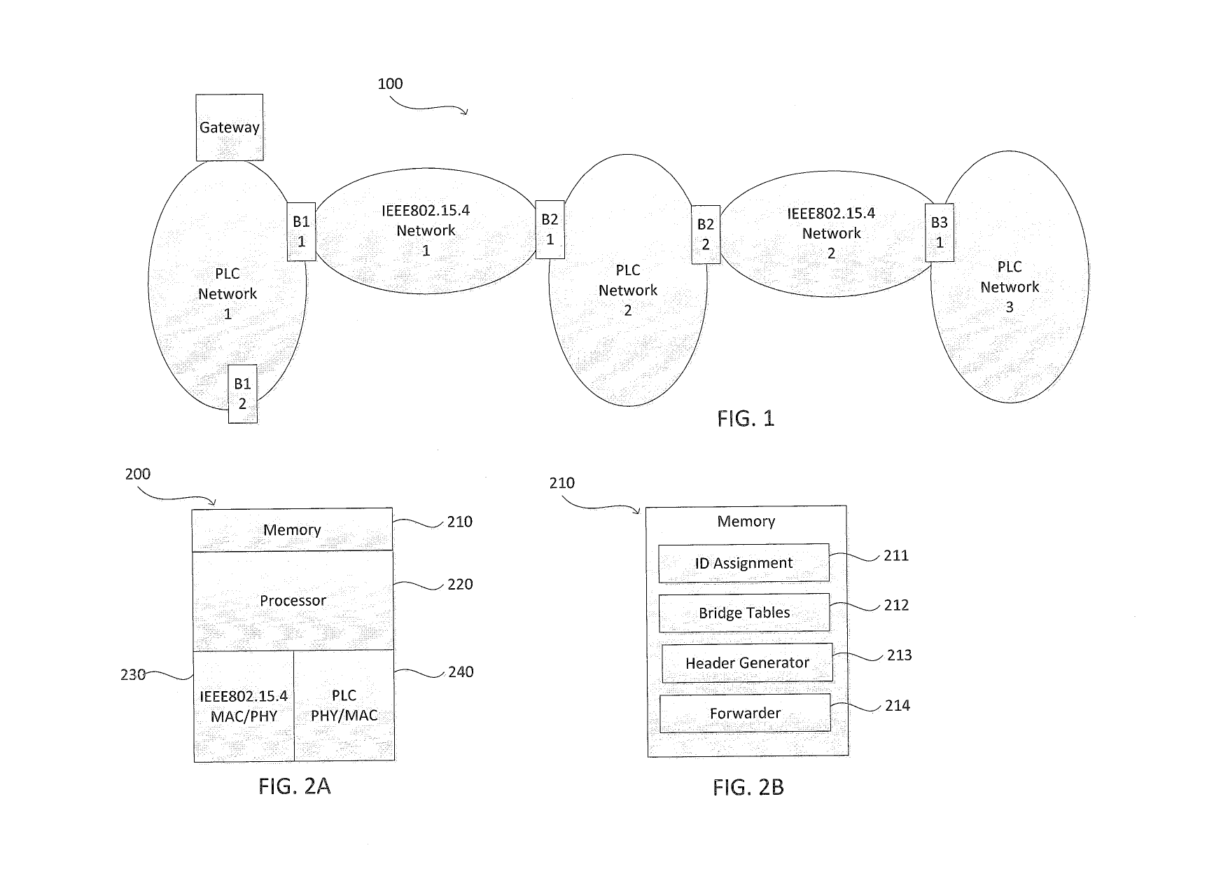

FIG. 2A is a block diagram illustrating a bridge device 200. Bridge device has two MAC/PHYs 230 and 240, a processor 220, and memory 210. The processor executes bridging software and the memory 210 stores this software.

Note that it is assumed that bridge devices are also having memory constraints and processing constraints. Hence, in an embodiment, the number of bridges may be limited to 255. However, additional bridges can be used in other embodiments.

In an embodiment, for this kind of heterogeneous network, the device 200 limits packet size to 100 bytes; supports more than 255 devices in the network; extends range; meets memory constraints and enables data flows from Master to slave and vice-versa.

FIG. 2B is a block diagram illustrating the memory 220 of the bridge device 200. The memory includes an ID assignment logic 211, bridge table(s) 212, a header generator logic 213 and forwarder logic 214. The ID assignment logic 211 assigns IDs/addresses to devices in a bridge's network. For example, Bridge B21 will assign addresses to devices in the Broadband PLC Network 2 in FIG. 1. Address assignment will be discussed further below. The assigned address are stored in one or more bridge tables 212. The header generator 213 appends headers to received packets, as will be discussed further below. The forwarder 214 forward packets up or down the network.

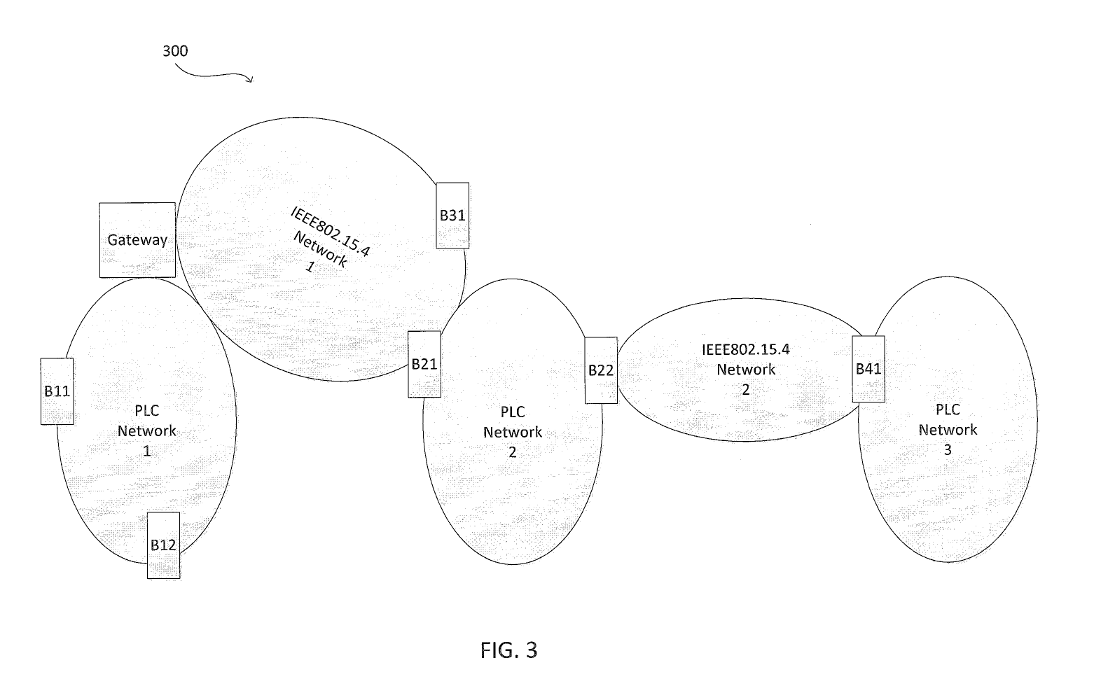

FIG. 3 is a block diagram illustrating a heterogeneous network 300. In this network 3 Broadband PLCnetworks are bridged using 2 IEEE802.15.4 networks. Each network comprises two types of devices: a Bridge device (e.g., the device 200) having forwarding capability and both Broadband PLC interface and IEEE802.15.4 interfaces; and non-Bridge devices that do not have forwarding capability, are reachable from the external network from the nearest best bridge device, and can be either Broadband PLC device or IEEE802.15.4 device which belongs to respective networks.

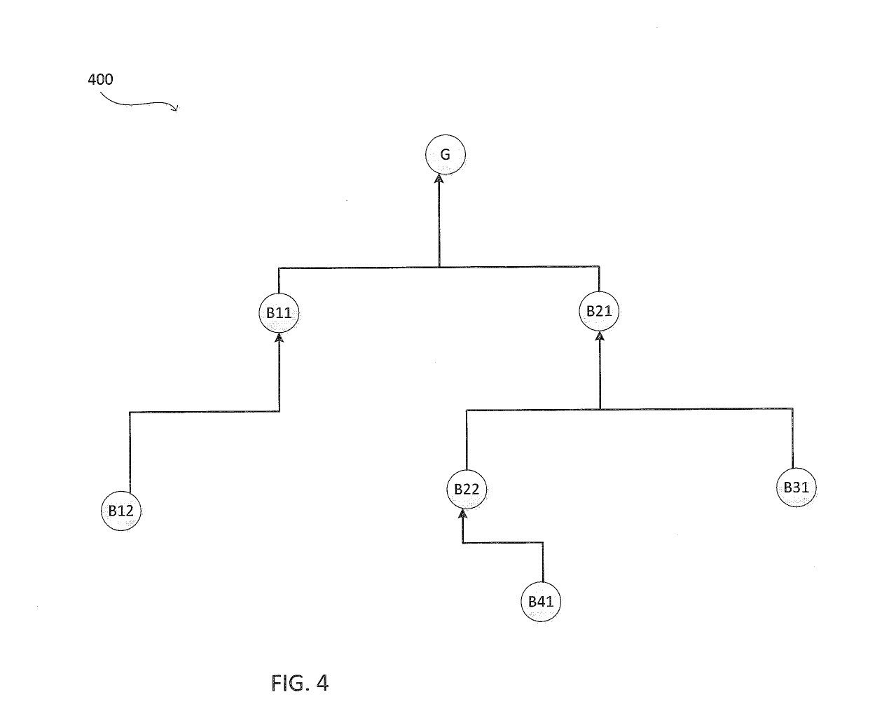

FIG. 4 is block diagram illustrating a network topology 400 of the network 300 of FIG. 3. G is the gateway device and is the root of this topology. All other bridge devices are called nodes in this topology. This network topology 400 shows that how bridge devices are connected to the network and are reachable from the root node G. Note, in an embodiment, only bridge nodes have forwarding capability. Both nodes and the gateway can be implemented using the bridge device 200.

Formation of the topology 400 is as follows:

Root node G boots up and is ready.

B11 boots up and tries to find its neighboring nodes.

B11 gets response from the neighboring nodes and it selects node which is closest to the root node.

Selection of the best neighbor can be done based on metric. Best neighbor is the one which is reachable from the root node and has good link with this node. Best neighbor node is called parent node with respect to the device.

B11 selects root node G.

G becomes parent of B11. B11 becomes child of G.

B21 boots up and tries to find its neighboring nodes.

B31 and G responds, B21 selects root node G.

B22 boots up and tries to find its neighboring nodes

B21 responds. B22 selects B21 as its best neighbor

B21 becomes the parent of B22 device

Parent is selected such that it is attached to the network and is reachable from G. Parent device can make sure that it is reachable from the root.

After parent selection is done, each device registers itself with the gateway. Device informs gateway who is his parent device. Packets are forwarded to the parent, which forwards them to the root and vice-versa

Gateway software (i.e., ID assignment logic 211) allocates unique network ID to each of the device in the network during registration of the device with the gateway.

For Broadband PLC network, each Broadband PLC device has a unique network ID (7 bytes) (NID). For IEEE802.15.4 wireless network, each network has unique PAN ID (2 bytes) as mentioned in the IEEE802.15.4-2006 specification. Hence, both of the networks can have their unique network IDs.

During registration process, each device sends its network ID to the Gateway. Gateway verifies network ID and issues unique Network address to the device. In an alternate approach, rather than device sending NID to the Gateway, it is possible for the Gateway to assign NIDs for each device during registration process. Network addresses are of two bytes of which first byte can uniquely identify network (PLC or Wireless) and second byte can uniquely identify device with in the network/sub-network of the heterogeneous network. Hence, Gateway assigns unique network address to each of the device based on device's own network ID (NID or PAN ID). It is possible that network address can be of more than 2 bytes, but it will increase memory requirements.

| Byte 1 | Byte 0 |
|---|---|
| Network Identifier byte | Device ID |

Gateway SW gets Broadband PLC Network ID or IEEE802.15.4 Network ID and device ID from the device during registration process. Device ID of the Broadband PLC device can be a Terminal Equipment identifier (TED. This is a Broadband PLC MAC short address which uniquely identifies any device in the Broadband PLC network. It is a 1 byte address so maximum devices number of devices supported in single Broadband PLC network is limited to 255.

As per spec, Device ID of the IEEE802.15.4 is 2 bytes ID. Hence, the maximum number of devices supported is 64K.

For the network identifier byte (NIB), Bit0 to Bit 6 are used for Broadband PLC network identification. Bit7 is used for IEEE802.15.4 network identification. NIB for Broadband PLC device has Bit7 set to zero and for IEEE802.15.4 device it is set to 1. Hence, maximum numbers of Broadband PLC networks which can be used are 127, in an embodiment. There is no such restriction for IEEE802.15.4 networks. In other embodiments, there may be no maximum.

For each of the Broadband PLC devices, the gateway software determines network address as follows:

Network identifier byte (NIB) is assigned based on the network ID of the Broadband PLC device to which it belongs to.

Each Broadband PLC network is assigned a unique NIB, which is assigned to the device.

Device ID (Byte 0) of the Network Address is same as the Broadband PLC TEI. Broadband PLC TEI is sent by the device during registration process.

| Byte 1 | Byte 0 |
|---|---|
| Network Identifier byte | HPGP TEI |
| (Bit7 = 0) | |

This way each of the Broadband PLC devices gets a unique Network Address.

For each of the IEEE802.15.4 devices, the gateway software determines network address as follows:

NIB is assigned based on the unique PAN ID of the network or new device being registered.

Device ID is assigned based on the available ID for the new device.

E.g first device will get 0 device id, next will get 1, etc.

| Byte 1 | Byte 0 |
|---|---|
| Network Identifier byte | Available Device id |
| (Bit7 = 1) | |

This way each of the IEEE802.15.4 devices gets a unique Network Address.

Note the Bridge device has both Broadband PLC and IEEE802.15.4 interfaces. Therefore, the Bridge device is assigned a Network Address based on Broadband PLC assigning mechanism as mentioned above.

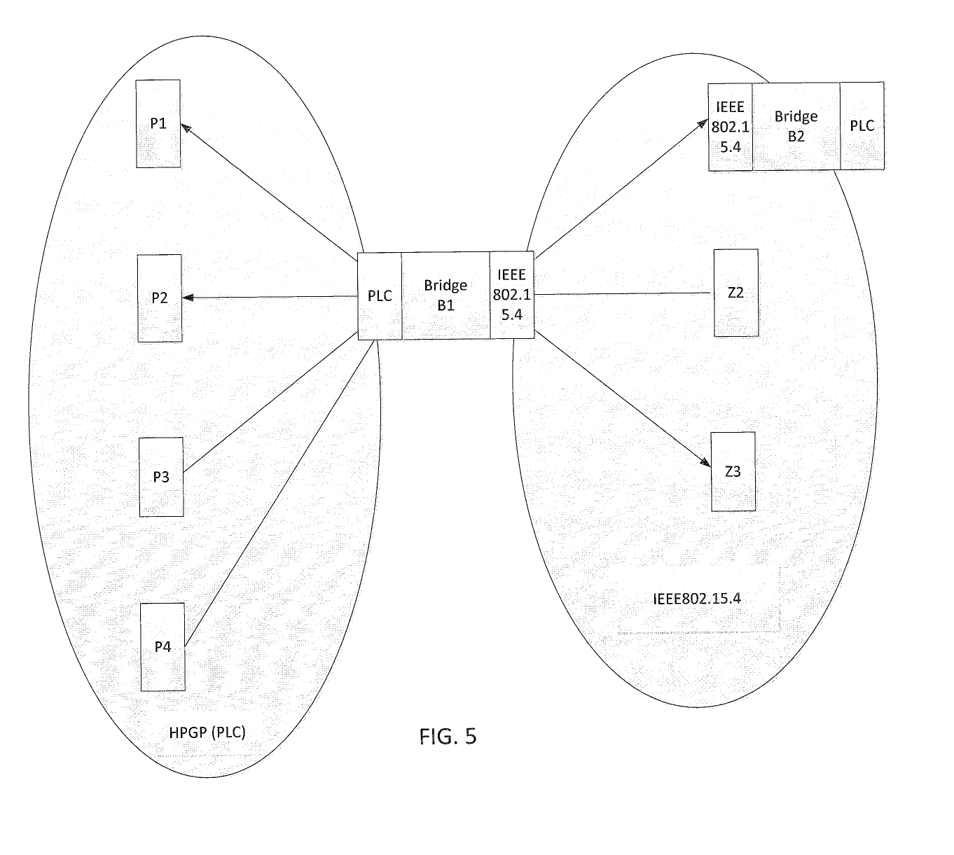

FIG. 5 is a block diagram illustrating bridge node interfaces. Each of the bridge devices will have both PLC and Wireless interfaces (PLC+Wireless). Bridge will be connected to the Broadband PLC devices and/or IEEE802.15.4 devices.

Broadband PLC only devices are directly connected to the Bridge. One of the bridge devices becomes CCO (Central Coordinator) for the Broadband PLC devices. Broadband PLC short address called TEI (Terminal Equipment Identifier) is a single byte address assigned by CCO (Central Coordinator) to each of the STA (Station) during MAC layer association. Broadband PLC network is a star network. 254 maximum Broadband PLC devices can be connected to the bridge device (CCO). TEI is sent to the gateway by the device during registration process.

IEEE802.15.4 only devices are directly connected to the Bridge.

IEEE802.15.4 interface of the bridge device temporarily assigns random id as a short address of the interface. This temporary network address is used for the communication until it registers with the gateway and gets unique network address from it. Unique network address replaces temporary address.

Gateway assigns unique network address to the bridge device based on Broadband PLC addressing as described above. This network address is used for IEEE802.15.4 and Broadband PLC interfaces (only TEI part). IEEE 802.15.4 replaces temporary address.

Bridge software gets its network address from the gateway as discussed above. Bridge device will replace temporary short address of the IEEE802.15.4 interface with the new Network Address received from the Gateway. Previous temporary short address is overwritten with the new address which is received from the gateway. This way each of the IEEE802.15.4 devices in the network has a unique Network Address.

In FIGS. 5, P1, P2, P3 and P4 Broadband PLC devices belong to the Broadband PLC network and are interfaced with Broadband PLC interface of the Bridge B1.

Z2 and Z3 IEEE802.15.4 devices belong to the IEEE802.15.4 network and are reachable using IEEE802.15.4 interface of the bridge device.

Advantages of having Network Address format as shown above may include:

Bridge device software can determine TEI from the network address of the received packet and can forward packet to the Broadband PLC device directly using extracted TEI. This allows bridge not to store devices (IEEE MAC Addresses) which are in its local networks such as other Broadband PLC devices (non-bridge devices).

Bridge device software can also set network address of the IEEE802.15.4 interface same as the Network Address received from the Gateway. This allows having unique network address of each of the IEEE802.15.4 interface.

Bridge device SW software can determine whether destination device (child) is over PLC or IEEE802.15.4 network using Network Address NIB field. This also allows bridge not to store devices which are in its local networks such as other Broadband PLC devices (non-bridge devices) or IEEE802.15.4 devices.

In FIG. 5, B1 stores network address only of B2. It does not store address of any other device because it can always determine it from the network address.

The root node, in the Gateway, maintains a routing table, which comprises address of all of the devices in the network. When any device in the network boots up it registers itself with the root node, hence, root node becomes aware of the device network address and its associated parent network address. Root stores child devices parent id, device id, next hop id and link on which next hop device is reachable.

Non-root nodes, e.g., child nodes (bridge devices) each maintains a routing table that comprises network addresses of other devices in its subtree. This comprises all parent IDs, device IDs, next hop IDs and corresponding links of the next hop devices. Table size may be constrained by the total number of bridge devices in the network. Hence, memory may be constrained for this device. For example, in FIG. 4, B11 will store device id of B12; B21 will store device id of B41, B22 and B21.

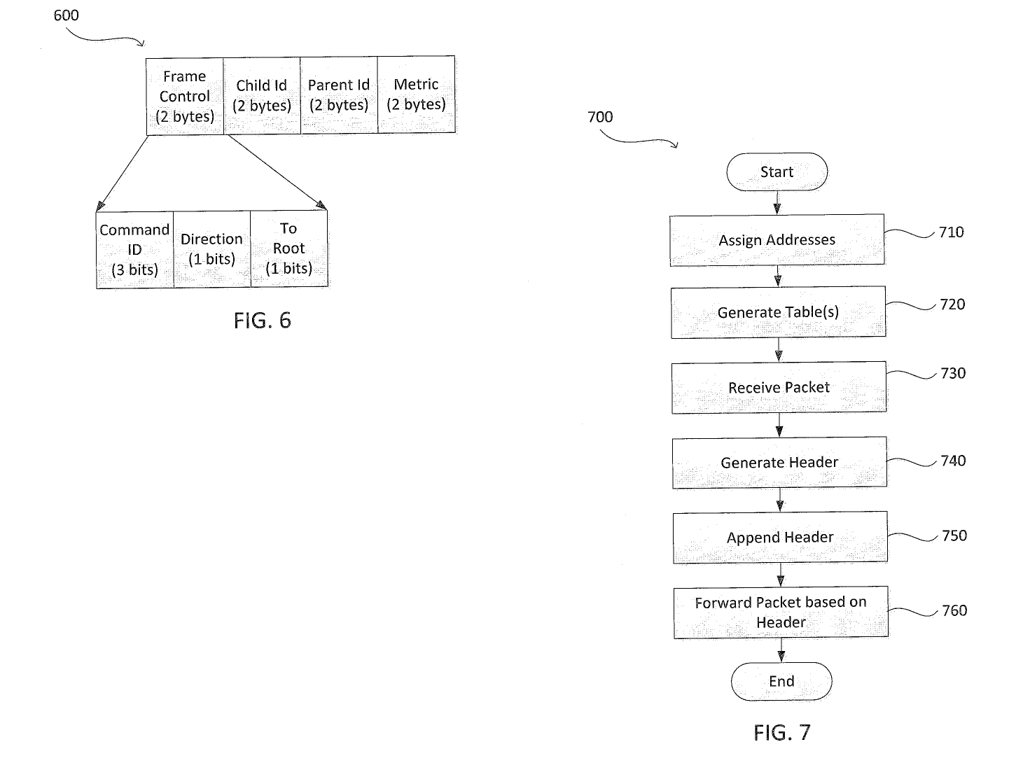

FIG. 6 is a diagram illustrating a network header 600 appended to packets. Any device in the network will append the network header 600 to each packet it transmits.

Frame Control includes command ID, Direction, To Root and reserved field. Command ID determines frame type. User can differentiate frames using this id.T

The direction field helps to determine whether packet should be forwarded or not. If direction is DOWN then packet should be forwarded to the device which is farther from the root node and node which is forwarding. If direction is UP, then packet should be forwarded to the device which is closer to the root node i.e., parent device.

The To Root field indicates if the packet is destined to the root.

Child ID indicates the Network address of the child device. Parent ID indicates the Network address of the parent of the given device. Metric helps in determining the distance of the node from the root and is a measure of device link with the parent. This field along with direction field is used to determine whether packet should be forwarded or not.

In the topology of FIG. 4, data flows in two directions—from root to the child (DOWN) or from child to the root (UP). Any node which wants to send data to the root can send their data to its parent device. Since parent is already reachable from root, device directly sends data to the parent. Parent node will further send data to his parent node, until data reaches to the root node. For example, B41 will send data to B22, B22 will forward to B21 and B21 will forward it to root B22 is the parent of B41, B21 is parent of B22, B11 is the parent of B21, and G is the parent of B11. When packet is sent from B41 to B22, packet header will be as follows

| | | | |
|---|---|---|---|
| Frame | B41 ID | B22 ID | B41 Metric |
| Control | | | |
| (Dir = UP) | | | |

When packet is sent from B21 to B11 which sends it to root, packet header remains same.

Root shall maintain knowledge or table of all of the devices in the network. Any device which comes up in the network shall register with root.

When root has to send data to the child, it will get following information from its table: Parent (network address) of the child device; and next hop device which is on the best path to reach the parent device.

When any bridge node other than root node receives packet, it will look up its table to find the parent or get next hop to reach to the parent and sends packet to the next hop address. Same is repeated until packet reaches to the parent device. Parent device forwards packet to its child based on the child's network address.

In FIG. 4, when root has to send packet to the B41, following network header is attached to the packet

| | | | |
|---|---|---|---|
| Frame | B41 ID | B22 ID | Root |
| Control | | | Metric |
| (Dir = | | | |
| DOWN) | | | |

From the network table, next hop is determined as B21. This packet is sent to B21. B21 determines next hop as B22 from its table. B22 matches with Parent ID. B22 determines whether B41's network address is over PLC or IEEE802.15.4 using network address (NIB, section 5.1.2).

If the address belongs to the Broadband PLC device, Broadband PLC device's TEI is obtained from the network address and packet is forwarded to the destination Broadband PLC device.

If the address belongs to the IEEE802.15.4 device, IEEE802.15.4 device's address is same as Network address of the child ID i.e., B41.

FIG. 7 is a flowchart illustrating a method 700 of transmitting data over a heterogeneous network. In an embodiment, the logic in the memory 210 can execute the method 700. The method 700 is employed in a network having heterogenous networks, i.e., IEEE 802.15.4 and powerline, e.g., Broadband PLC. First, addresses are assigned (710) to the devices in the networks. Then, table(s) are generated (720) as described above. Then a packet is received (730). If the packet is from the bridge's network, then it generates (740) and appends (750) as described above. The packet is then forwarded (760) per the header. If the packet already has a header, then the packet is forwarded (760) based on header information.

Route Maintenance—Every device in the whole network sends periodic keep alive frames to the gateway. These periodic frames carry devices network address, it's parent address, device type (bridge device/non bridge device) etc. Since this packet goes through the best path to reach the Gateway, this information (parent id and device network address) is used by the bridge devices and gateway to update or maintain route table. Route table in the bridge devices store route information for the all bridge devices for which it receives periodic keep alive frame.

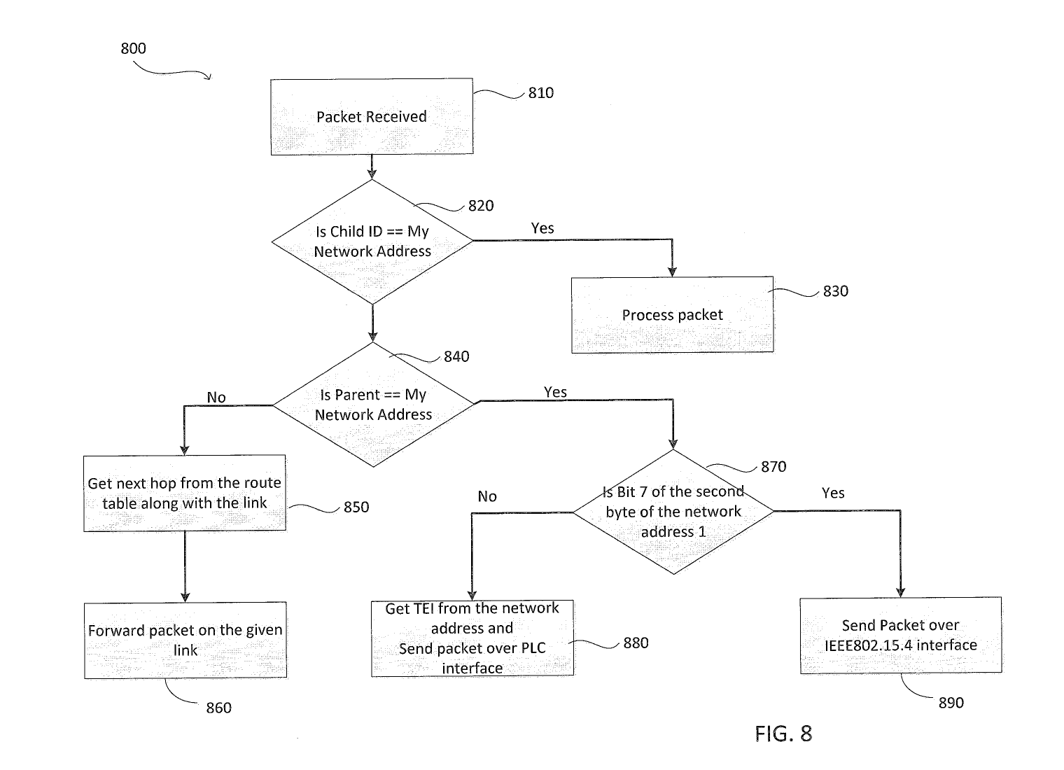

FIG. 8 is a flowchart illustrating a method 800 of processing a packet at a bridge device. When a bridge receives (810) packet, it checks Child ID in the packet header. If child ID matches (820) with the bridge device network address then packet is processed (830).

If not, Parent ID is matched (840) the network address, if matched, packet is forwarded to either PLC (880) or IEEE802.15.4 network (890). Bit 7 of the second byte of the child ID is used (870) to identify over which network packet is to be forwarded.

If Parent ID does not match (840), next hop network address and link is extracted (850) from the routing table and packet is forwarded (860) to the given network address over the given link

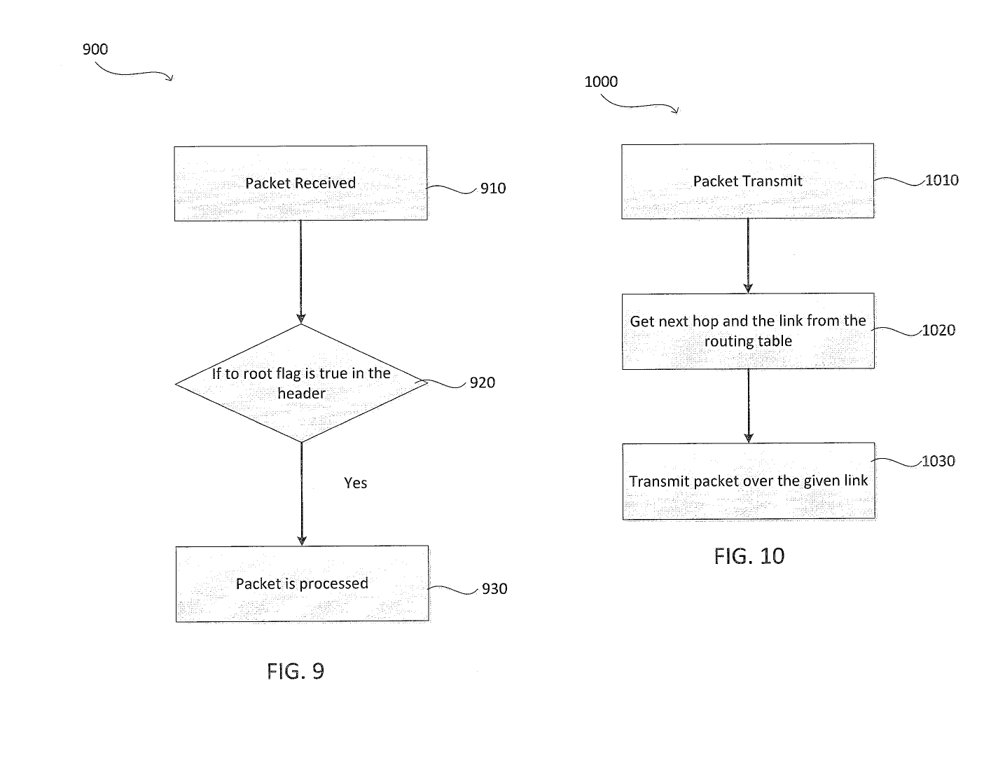

FIG. 9 is a flowchart illustrating a method 900 of processing a received packet at a gateway device. A packet is received (910). For the received packet, check (920) to root flag, if true process (930) the packet.

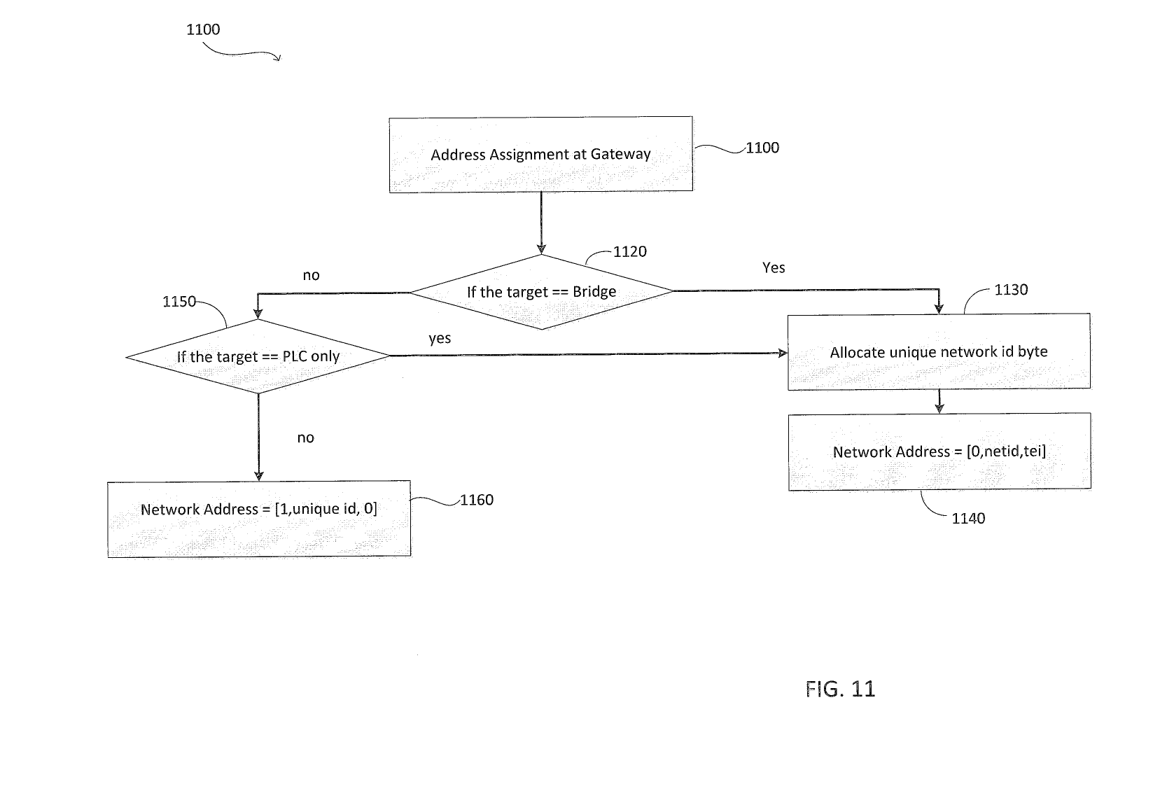

FIG. 10 is a flowchart illustrating a method 1000 of transmitting a packet at a gateway device. For the transmitted packet, get (1020) the next hop network address from the routing table and transmit (1030) the packet.

FIG. 11 is a flowchart illustrating a method 1100 of assigning an address at a gateway device. The gateway assigns (1100) an Address based on the interface type. If (1120) the target (Child) is a bridge device, allocate (1130, 1140) network address as Bit 7 of second byte as 0, Bit 6 to Bit 0 of the second byte—generate unique network id, Bit7 to Bit 0 as a TEI of the device. TEI is received from the device.

If (1150) the target is IEEE802.15.4 only device, assign (1160) network address as Bit7 of the second byte as 1, Bit6 to 0 as unique id (randomly generated), Bit 0 to Bit7 of the first byte as 0.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, means: a) special-purpose hardwired circuitry, such as one or more application-specific integrated circuits (ASICs), programmable logic devices (PLDs), field programmable gate arrays (FPGAs), or other similar device(s); b) programmable circuitry programmed with software and/or firmware, such as one or more programmed general-purpose microprocessors, digital signal processors (DSPs) and/or microcontrollers, or other similar device(s); or c) a combination of the forms mentioned in a) and b).

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method in a heterogeneous network comprising at least one wireless subnetwork and at least one powerline communication (PLC) subnetwork, each of the subnetworks comprising at least one device, the subnetworks bridged by a bridge device, the method comprising:
determining, by the bridge device, neighboring nodes after a root node boots;
assigning, by the bridge device, a neighboring node closest to the root node as a parent node;
receiving, from each device in a subnetwork of the bridge device, a registration request;
forwarding, by the bridge device, the registration request, to the root node;
receiving assignments of a network address for each subnetwork device, the network address having a size of two bytes and comprising a network identifier and device identifier.

2. The method of claim 1, wherein the device identifier is the Terminal Equipment Identifier if the subnetwork is PLC.

3. The method of claim 1, wherein the network identifier is based on a PAN ID of the subnetwork if the subnetwork is wireless.

4. The method of claim 1, further comprising maintaining a routing table of all other bridges in the heterogeneous network.

5. The method of claim 4, further comprising maintaining a neighbor table of neighboring nodes.

6. The method of claim 5, further comprising:
receiving a packet from the subnetwork;
checking if the packet has a header;
appending a header to the packet if the packet does not have a header, the header including direction, Child ID, Parent ID, metric of originator of packet, and To Root if the packet is destined to travel to the root node; and
transmitting the packet.

7. The method of claim 6, wherein the transmitting is in unicast to a device in the subnetwork.

8. A bridge device configured to operate in a heterogeneous network comprising at least one wireless subnetwork and at least one powerline communication (PLC) subnetwork, each of the subnetworks comprising at least one device, comprising:
a wireless MAC/PHY;
a PLC MAC/PHY;
a processor communicatively coupled to both MAC/PHYs; and
at least one memory comprising instructions configured to cause the processor and MAC/PHYs to:
determine neighboring nodes after a root node boots;
assign a neighboring node closest to the root node as a parent node;
receive, from each device in a subnetwork of the bridge device, a registration request;
forward the registration request to the root node;
receive assignments of a network address for each subnetwork device, the network address having a size of two bytes and comprising a network identifier and device identifier.

9. The device of claim 8, wherein the device identifier is the Terminal Equipment Identifier if the subnetwork is PLC.

10. The device of claim 8, wherein the network identifier is based on a PAN ID of the subnetwork if the subnetwork is wireless.

11. The device of claim 8, wherein the at least one memory further comprises instructions configured to cause the processor to maintain a routing table of all other bridges in the heterogeneous network.

12. The device of claim 11, wherein the at least one memory further comprises instructions configured to cause the processor to maintain a neighbor table of neighboring nodes.

13. The device of claim 12, wherein the at least one memory further comprises instructions configured to cause the processor and MAC/PHYs to:
receive a packet from the subnetwork;
check if the packet has a header;
append a header to the packet if the packet does not have a header, the header including direction, Child ID, Parent ID, metric of originator of packet, and To Root if the packet is destined to travel to the root node; and
transmit the packet.

14. The device of claim 13, wherein the transmitting is in unicast to a device in the subnetwork.
